(19) United States
(12) Patent Application Publication
(10) Pub. No.: US 2010/0268694 A1
(43) Pub. Date: Oct. 21, 2010

(54) SYSTEM AND METHOD FOR SHARING WEB APPLICATIONS

(76) Inventors: Laurent Denoue, Palo Alto, CA (US); Scott Carter, Los Altos, CA (US); John Adcock, San Francisco, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/426,142

(22) Filed: Apr. 17, 2009

(51) Int. Cl. G06F 17/30

(52) U.S. Cl. 707/693; 707/E17.001

(57) ABSTRACT

A system and a method for sharing web pages. In some embodiments, the following operations are preformed at a client computer system having one or more processors that execute one or more programs stored in memory of the client computer system. A representation of a web page that is displayed in a window of a web browser in a user interface of the client computer system is generated. The representation of the web page is partitioned into a plurality of tiles based on a document object model of the web page. For each tile in the plurality of tiles, it is determined whether the tile has changed relative to a previous version of the tile. In response to determining that the tile has changed, the tile that has changed is sent to a server.

### TECHNICAL FIELD

The disclosed embodiments relate generally to sharing web applications between a first computer system and a second computer system.

### BACKGROUND

As broadband Internet usage increases, more business is being conducted on the Internet. For example, presentations such as web conferences, software training, and web application demonstrations are routinely conducted online. Screen-casting (or screen-sharing) applications facilitate these types of presentations. A presenter may use a screen-casting application to share content being displayed on the presenter's computer system with one or more users (e.g., subscribers) on client computer systems. The screen-casting application may allow the presenter to share the entire desktop or to share a single window displayed on the presenter's computer system. Unfortunately, existing screen-casting applications are not well-suited for sharing web applications displayed in a web browser.

Existing screen-casting applications may record and encode a video (e.g., using a video codec such as H.264, etc.) representing the shared desktop or the shared window. The video codecs used in existing screen-casting applications typically send differences between a previous frame and a current frame of the video. Thus, if a current frame has not changed relative to the previous frame, the amount of data encoded for the current frame is minimal. Unfortunately, if there are changes between the current frame and the previous frame, the amount of data encoded for the current frame may increase substantially. Web applications typically include content that exceeds the bounds of the viewable area of a window of a web browser. For example, the window of the web browser may only display a portion of a web page for the web application. To view the rest of the web application, the user must use the scrollbars to scroll the content (e.g., the web page) vertically and/or horizontally. Thus, a presenter may need to scroll the content when sharing a web application. In doing so, the screen-casting application must encode the new content being displayed in the presenter's computer system. Even a small scroll (a few pixels), would cause the screen-casting application to encode data for the current frame.

Moreover, existing screen-casting applications typically require both the presenter and the subscriber to download and install the screen-casting application. Unfortunately, existing screen-casting applications are typically platform-specific (e.g., Microsoft Windows, Mac OSX, etc.) and may not be supported on all platforms. For example, mobile devices may not be supported by screen-casting applications.

Existing screen-casting applications also require a substantial amount of bandwidth. Thus, to handle the bandwidth requirements, existing screen-casting applications typically use native socket connections to communicate with a server or a presenter's computer system. Unfortunately, using native sockets requires opening ports in a firewall, which may be a security risk. Furthermore, to reduce the bandwidth required to transmit videos and the processing power required to encode the videos, existing screen-casting applications typically reduce the resolution of the encoded frames. Unfortunately, reducing the resolution results in videos where viewers may not be able to read text included in the videos.

Existing screen-casting applications also do not allow users to easily search for and retrieve the videos produced. For example, existing screen-casting applications are typically only searchable through metadata (e.g., title, specified tags, etc.). There is currently no way for users to search the content being presented in the videos (e.g., text in the web browser's window that the presenter is broadcasting). Thus, it is impossible for viewers to locate portions of the video via a keyword search.

Existing screen-casting applications cannot share a single tab of a web browser window. At most, existing screen-casting applications only let presenters specify a region of interest as a rectangle. However, the presenter cannot subsequently move the window. Also, if the presenter switches tabs or if another window takes focus over the shared region (e.g., an instant messaging window), the other window will also be shared.

Existing screen-casting applications may also use desktop sharing protocols to share content being displayed one the presenter's system. For example, these desktop sharing protocols include Microsoft's Remote Desktop Protocol (RDP) and the Remote Frame Buffer (RFB) (e.g., as used in some implementations of Virtual Network Computing (VNC)). Unfortunately, these protocols also suffer the same problems as described above.

Thus, it is highly desirable to provide a system and method for sharing web applications without the aforementioned drawbacks.

### SUMMARY

Some embodiments provide a system, a computer readable medium including instructions, and a method for sharing web pages. In some embodiments, the following operations are preformed at a client computer system having one or more processors that execute one or more programs stored in memory of the client computer system. A representation of a web page that is displayed in a window of a web browser in a user interface of the client computer system is generated. The representation of the web page is partitioned into a plurality of tiles based on a document object model of the web page. For each tile in the plurality of tiles, it is determined whether the tile has changed relative to a previous version of the tile. In response to determining that the tile has changed, the tile that has changed is sent to a server.

In some embodiments, after partitioning the representation of the web page into the plurality of tiles, each tile in the plurality of tiles is compressed to produce a compressed tile.

In some embodiments, it is determined whether the tile has changed relative to the previous version of the tile as follows. A signature of the compressed tile is computed. It is determined whether the signature of the compressed tile is different than a previously computed signature of the previous version of the compressed tile. In response to determining that the signature for the compressed tile is different than the previously computed signature of the previous version of the compressed tile, it is determined that the compressed tile has changed.

In some embodiments, the signature of the compressed tile is computed as follows. A hash value of the compressed tile is computed using a hash function.

In some embodiments, the signature of the compressed tile is sent to the server.

In some embodiments, the tile that has changed is sent to the server as follows. The compressed tile that has changed is sent to the server.

In some embodiments, it is determined whether the tile has changed relative to the previous version of the tile as follows. A signature of the tile is computed. It is determined whether the signature of the tile is different than a previously computed signature of the previous version of the tile. In response to determining that the signature for the tile is different than the previously computed signature of the previous version of the tile, it is determined that the tile has changed.

In some embodiments, the signature of the tile is computed as follows. A hash value of the tile is computed using a hash function.

In some embodiments, the signature of the tile is sent to the server.

In some embodiments, the representation of the web page is partitioned into the plurality of tiles based on the document object model of the web page as follows. A viewable area of the web page is determined based on the document object model. The viewable area of the web page is then partitioned into the plurality of tiles.

In some embodiments, the representation of the web page is partitioned into the plurality of tiles based on the document object model of the web page as follows. A viewable area of the web page is determined based on the document object model. A scrollable area of the web page is determined based on the document object model. The viewable area and the scrollable area of the web page are then partitioned into the plurality of tiles.

In some embodiments, the representation of the web page is partitioned into the plurality of tiles based on the document object model of the web page as follows. A viewable area of the web page is determined based on the document object model. A scrollable area of the web page is determined based on the document object model. The viewable area and a subset of the scrollable area of the web page are then partitioned into the plurality of tiles.

In some embodiments, the document object model of the web page is queried to determine nodes of the web page that are within each tile. Words and/or characters in the nodes are determined based on the document object model. The words and/or characters are sent to the server.

In some embodiments, bounding boxes for the words and/or characters in the nodes are determined based on the document object model. The bounding boxes are then sent to the server.

In some embodiments, in response to determining that the tile has changed, a timestamp corresponding to a time when the tile was generated is generated. The timestamp is then sent to the server.

In some embodiments, the document object model the web page is queried to determine bounding boxes for content within each tile of the plurality of tiles, wherein the content is displayed using plug-in modules of the web browser. Areas in each tile corresponding to the bounding boxes are masked. Representations of the content are then generated. The representations of the content and the bounding boxes are sent to the server.

In some embodiments, a position of a cursor is determined and is sent to the server.

In some embodiments, a respective tile includes metadata.

In some embodiments, the metadata includes a name of the respective tile, a position of the respective tile in the web page, and a timestamp indicating a time when the respective tile was generated.

In some embodiments, the representation of the web page is an image of the web page.

In some embodiments, the image of the web page is a bitmap image of the web page.

In some embodiments, session data is determined and is sent to the server.

In some embodiments, the session data includes: a session identifier, a height of second window, a width of second window, a scrollable height of the web page, a scrollable width of the web page, a vertical position of a vertical scroll bar, a horizontal position of a horizontal scroll bar, and a cursor shape.

Some embodiments provide a system, a computer readable medium including instructions, and a method for viewing shared web pages. In some embodiments, the following operations are preformed at a first client computer system having one or more processors that execute one or more programs stored in memory of the first client computer system. A tile from a plurality of tiles representing a web page that is displayed in a second window of a second web browser in a second user interface of a second client computer system is received from a server. A position of the tile within the web page is determined. The tile is then displayed at the position within a first window of a first web browser in a first user interface of the first client computer system.

In some embodiments, the tile includes metadata.

In some embodiments, the metadata of the tile includes a name of the tile, a position of the tile in the web page, and a timestamp indicating a time when the tile was generated.

In some embodiments, the position of the tile is determined based on the metadata.

In some embodiments, the tile is an image.

In some embodiments, a current position of a cursor is received from the server. It is determined whether the current position of the cursor is the same as a previous position of the cursor. In response to determining that the current position of the cursor is different than the previous position of the cursor, an animation that produces a movement of the cursor from the previous position of the cursor to the current position of the cursor is generated. The animation is then displayed in the first window of the first web browser.

In some embodiments, prior to receiving the tile from the server, session data is received. A container is generated within the first window of the first web browser based on the session data. An initial set of the plurality of tiles is received from the server. At least a subset of the initial set of the plurality of tiles is displayed in the container in the first window of the first web browser. A cursor is displayed in the first window of the first web browser based on the session data.

In some embodiments, the session data includes a session identifier, a height of the second window, a width of the second window, a scrollable height of the web page, a scrollable width of the web page, a vertical position of a vertical scroll bar, a horizontal position of a horizontal scroll bar, and a cursor shape.

In some embodiments, bounding boxes and corresponding words and/or characters are received from the server, wherein a respective bounding box corresponds to a specified location of a respective word and/or a respective character within a respective tile. A search query including search terms is received from a user of the first client computer system. At least one bounding box including the search terms is determined. At least one visual indicator corresponding to the at least one bounding box is displayed.

In some embodiments, bounding boxes and representations of content that are displayed using plug-in modules of the second web browser are received. The bounding boxes and the representations of the content are then displayed in the first window of the first web browser.

### BRIEF DESCRIPTION OF THE DRAWINGS

FIG. 1 is a block diagram of systems for sharing web pages and displaying shared web pages, according to some embodiments.

FIG. 2 is a block diagram illustrating a presenter computer system, according to some embodiments.

FIG. 3 is a block diagram illustrating a server, according to some embodiments.

FIG. 4 is a block diagram illustrating a client computer system, according to some embodiments.

FIG. 5 is a flowchart of a method for starting a session to share web pages, according to some embodiments.

FIG. 6 is a flowchart of a method for sharing a web page, according to some embodiments.

FIG. 7 is a block diagram illustrating a web page that is partitioned into a plurality of tiles, according to some embodiments.

FIG. 8 is a flowchart of a method for determining words and/or characters that are in a tile, according to some embodiments.

FIG. 9 is a flowchart of a method for handling content that is displayed using plug-in modules of a web browser, according to some embodiments.

FIG. 10 is a flowchart of a method for sharing a position of a cursor in a shared web page, according to some embodiments.

FIG. 11 is a flowchart of a method for displaying a shared web page, according to some embodiments.

FIG. 12 is a flowchart of a method for displaying a position of a cursor in a shared web page, according to some embodiments.

FIG. 13 is a flowchart of a method for performing a search on a shared web page, according to some embodiments.

FIG. 14 is a flowchart of a method for displaying content that is displayed using plug-in modules of a web browser, according to some embodiments.

Like reference numerals refer to corresponding parts throughout the drawings.

### DESCRIPTION OF EMBODIMENTS

### Overview

As discussed above, it is desirable to share web pages between users on different computer system. For example, a presenter may desire to share a demonstration of a web page or a web application to one or more viewers. Thus, some embodiments provide a system and method for sharing web pages and for retrieving and viewing shared web pages. These embodiments use a tile-based encoding technique to capture and deliver shared web pages. In some embodiments, the tile-based encoding technique uses web standards (e.g., Dynamic HTML, JavaScript, etc.).

Note that the term “web page” is used in this specification to refer to a “static web page” and/or a “dynamic web page.” A static web page is a web page in which the substantive content does not change. Static web pages include static content that does not change based on context (e.g., the content is the same content for all users, etc.) and are typically stored in files that are served directly by a web server on which the files are hosted. Dynamic web pages are web pages that include content that changes based on context (e.g., the content that may from user to user based on user input, etc.) and are built by a web server that executes a server-side script that obtains the content from a database. For example, a dynamic web page may be a web application (e.g., a web email application, a customer relationship management web application, etc.).

In some embodiments, a presenter on a presenter computer system publishes and/or broadcasts a shared web page to a server. One or more subscribers on client computer systems then subscribe to the published web page to view the shared web page.

In some embodiments, a web page is shared as a time sequence of images representing the content of the web page. Unlike existing screen-casting applications that produce an encoded video of the shared web page, each image of the web page (or each tile of the representation of the web page) in the time sequence of images of the web page is associated with a timestamp. The timestamp is used to display a respective image of the web page (or a respective tile of the representation of the web page) in time order. The benefit to these embodiments is that if the there is a long period of time where content of the shared web page does not change, a new image of the web page (or a new image of a respective changed tile) is not generated, thereby reducing bandwidth usage and storage requirements. When a new image is generated, the new image is associated with a timestamp so that the new image can be displayed in time order. Note that the time sequence of images is referred to as a “screencast” in this specification.

In some embodiments, the representations of the shared web pages are sent in full resolution. In some embodiments, the representations of the shared web pages are scaled prior to being sent.

In some embodiments, only outbound HTTP 80 connections are used. Thus, new ports in the firewall do not need to be opened.

In some embodiments, a server receives data from a program (e.g., JavaScript program) that is executed on a presenter computer system and that captures shared web pages. In some embodiments, subscribers connect to the server to obtain and view the screencasts. In some embodiments, the screencasts include only standard HTML elements and JavaScript programs. Thus, the screencasts are viewable by any web browser that supports standard HTML elements and JavaScript (e.g., Microsoft Internet Explorer, Mozilla Firefox, Safari, Safari on iPhone, etc.). In some embodiments, screencasts are produced and played back using Adobe Flash.

Unlike existing screen-casting applications, the screencasts generated by the embodiments described herein have several advantages. The screencasts generated by the embodiments described herein use information included in a document object model (DOM) of a web page to share the web page with subscribers. The screencasts generated by the embodiments described herein do not use video codecs. Thus, screencasts generated by the embodiments described herein require less bandwidth and less storage space. The embodiments described herein can share one or more browser windows and/or one or more tabs in the one or more browser windows. The embodiments described herein do not need native clients (e.g., VNC clients, etc.) to be installed on the presenter computer system and client computer system. Thus, the embodiments described herein can be viewed using any web browser that supports standard HTML and JavaScript. The screencasts generated by the embodiments described herein are also searchable (e.g., every keyword shown in the shared web page is captured and shared).

The embodiments described herein may be used in several exemplary scenarios. In a first example, a presenter for a web-based customer relationship management (CRM) application uses the embodiments described herein to demonstrate new features of web-based CRM. The presenter shares a window of a web browser that is running the web-based CRM. The presenter may record the presentation for subsequent playback and/or stream the presentation live to subscribers.

In a second example, a husband logs onto a car reservation website. The husband enters in the required information. However, when the car reservation website asks the husband to select a vehicle to reserve, the husband needs to coordinate with his wife. The husband uses the embodiments described herein to share the web browser tab that is displaying the car reservation website with his wife.

In a third example, a user of a web application receives a cryptic error message. The user uses the embodiments described herein to share the web browser window displaying the error message with a technical support representative for the web application. The technical support representative guides the user to resolve the error.

### Systems

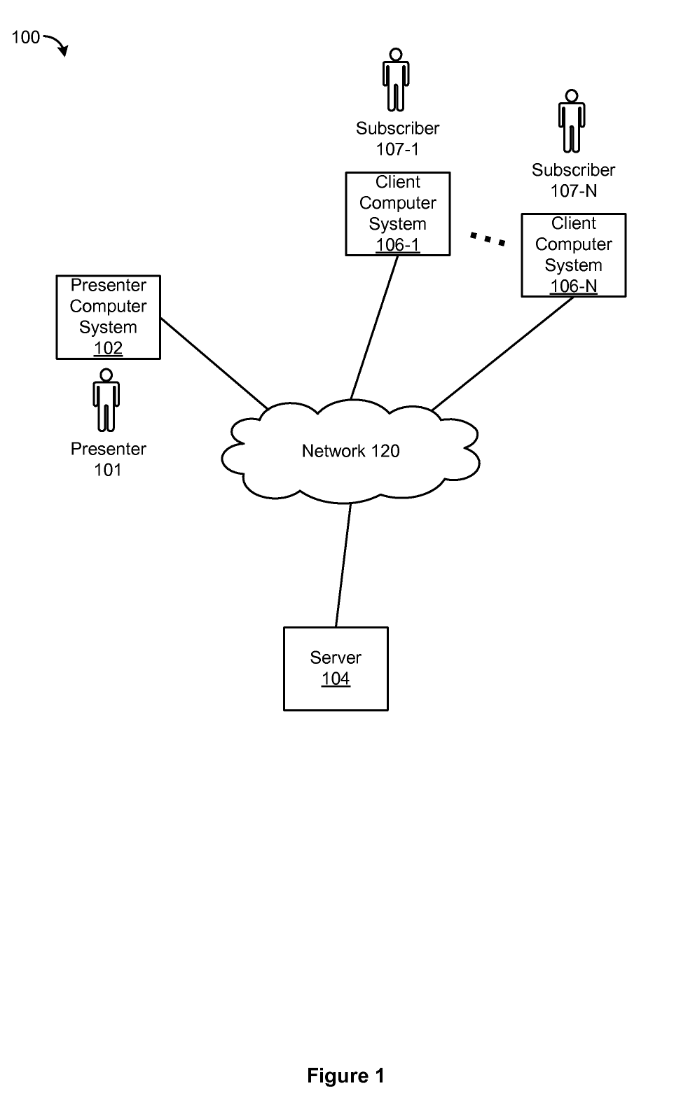

FIG. 1 is a block diagram 100 of systems for sharing web pages and displaying shared web pages, according to some embodiments. FIG. 1 includes a presenter computer system 102, a server 104, and client computer systems 106. The presenter computer system 102, the server 104, and the client computer systems 106 are coupled to each other via a network 120. The network 120 may include any type of wired or wireless communication channel capable of coupling together computing nodes. This includes, but is not limited to, a local area network, a wide area network, or a combination of networks. In some embodiments, the network 120 includes the Internet.

In some embodiments, the presenter computer system 102 is a computer system at which a presenter 101 is sharing a web page with the client computer systems 106 via the network 120. In some embodiments, the presenter computer system 102 includes a desktop computer system, laptop computer system, a personal digital assistant, a smart phone, a mobile phone, a set-top box, or the like.

In some embodiments, the client computer systems 106 are computer systems at which subscribers 107 receive the shared web page via the network 120. In some embodiments, the client computer systems 106 include a desktop computer system, laptop computer system, a personal digital assistant, a smart phone, a mobile phone, a set-top box, or the like.

Note that the distinction between the presenter computer system and the client computer systems 106 is made for the sake of clarity. In general, any of the client computer systems 106 may also share web pages and the presenter computer system 102 may display a shared web page.

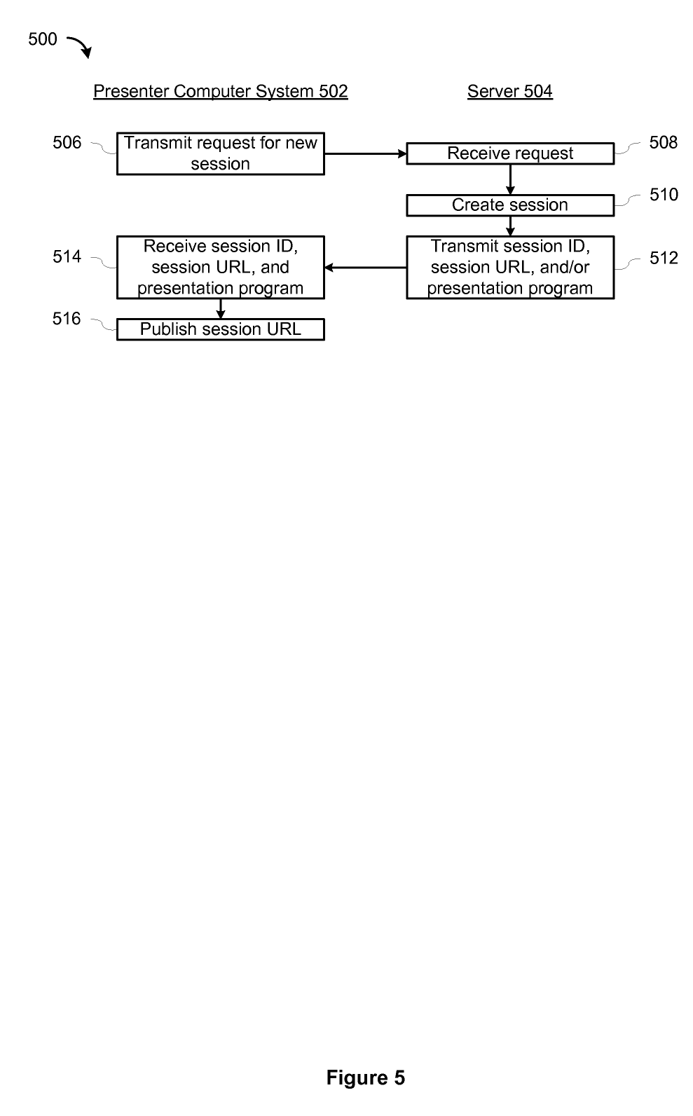

In some embodiments, the presenter computer system 102 broadcasts a shared web page to the client computer systems 106 via the server 104. In these embodiments, the presenter computer system 102 transmits a sequence of representations of the web page to the server 104 via network 120. The client computer systems 106 then receive the sequence of representations from the server 104 and display it to the subscribers 107. These embodiments are described in more detail with respect to FIGS. 5-14.

In some embodiments, the server 104 hosts a presentation program that includes instructions for sharing web pages, for viewing shared web pages, or a combination thereof. In some embodiments, the presenter computer system 102 executes the presentation program to share web pages. In some embodiments, the client computer systems 106 execute the presentation program to receive and display shared web pages. In some embodiments, the presentation program is a JavaScript program that is executed within a web browser of the presenter computer system 102 or the client computer systems 106. Note that using JavaScript for the programs is beneficial because JavaScript is typically included in most web browsers. Thus, the programs can be used across multiple platforms and multiple devices as long as those platforms and devices support web browsers with a JavaScript engine. In some embodiments, the presentation program is a browser extension is installed in the web browser.

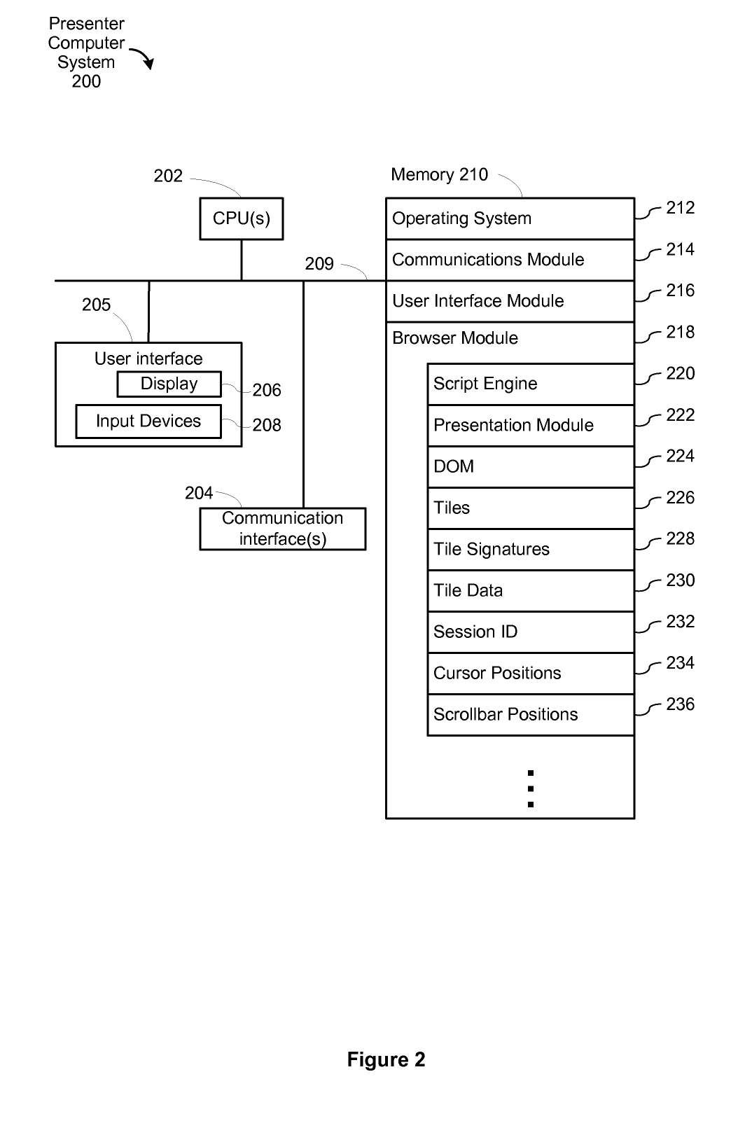

FIG. 2 is a block diagram illustrating a presenter computer system 200, according to some embodiments. The presenter computer system 200 can be the presenter computer system 102 in FIG. 1. The presenter computer system 200 typically includes one or more processing units (CPU's) 202, one or more network or other communications interfaces 204, memory 210, and one or more communication buses 209 for interconnecting these components. The communication buses 209 may include circuitry (sometimes called a chipset) that interconnects and controls communications between system components. The presenter computer system 200 also includes a user interface 205 comprising a display device 206 and input devices 208 (e.g., keyboard, mouse, touch screen, keypads, etc.). Memory 210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 210 may optionally include one or more storage devices remotely located from the CPU(s) 202. Memory 210, or alternately the non-volatile memory device(s) within memory 210, comprises a computer readable storage medium. In some embodiments, memory 210 stores the following programs, modules and data structures, or a subset thereof:
an operating system 212 that includes procedures for handling various basic system services and for performing hardware dependent tasks;
a communication module 214 that is used for connecting the presenter computer system 200 to other computer systems via the one or more communication interfaces 204 (wired or wireless) and one or more communication networks, such as the Internet, other wide area networks, local area networks, metropolitan area networks, and so on;
a user interface module 216 that receives commands from a user via the input devices 208 and generates user interface objects in the display device 206; and
a browser module 218 that includes a script engine 220 (e.g., a Java Virtual Machine, a JavaScript engine, an ActiveX engine, etc.) for executing scripts and/or programs (e.g., JavaScript programs, etc.), a presentation module 222 (e.g., the JavaScript program or web browser extension that includes instructions for sharing web pages with client computer systems), a document object model (DOM) 224 that includes an object model for representing a web page in to be displayed by the browser module 218 on the display device 206, tiles 226, tile signatures 228, tile data 230 (e.g., tile metadata, words and/or characters associated with tiles, bounding boxes for words and/or characters associated with tiles, multimedia content associated with tiles, timestamps associated with tiles, links associated with objects in tiles, etc.), a session ID 232, one or more cursor positions 234, and one or more scrollbar positions 236, as described herein.

Note that a DOM is an interface that allows programs (e.g., scripts, etc.) to dynamically access and update the content, style, and structure of a document. Typically, a DOM is a tree structure that includes a hierarchy of elements, attributes, and values. A DOM may also include locations of objects (e.g., text, images, videos, etc.) within the web page.

Although FIG. 2 shows a “presenter computer system,” FIG. 2 is intended more as functional description of the various features which may be present in a presenter computer system than as a structural schematic of the embodiments described herein. In practice, and as recognized by those of ordinary skill in the art, items shown separately could be combined and some items could be separated.

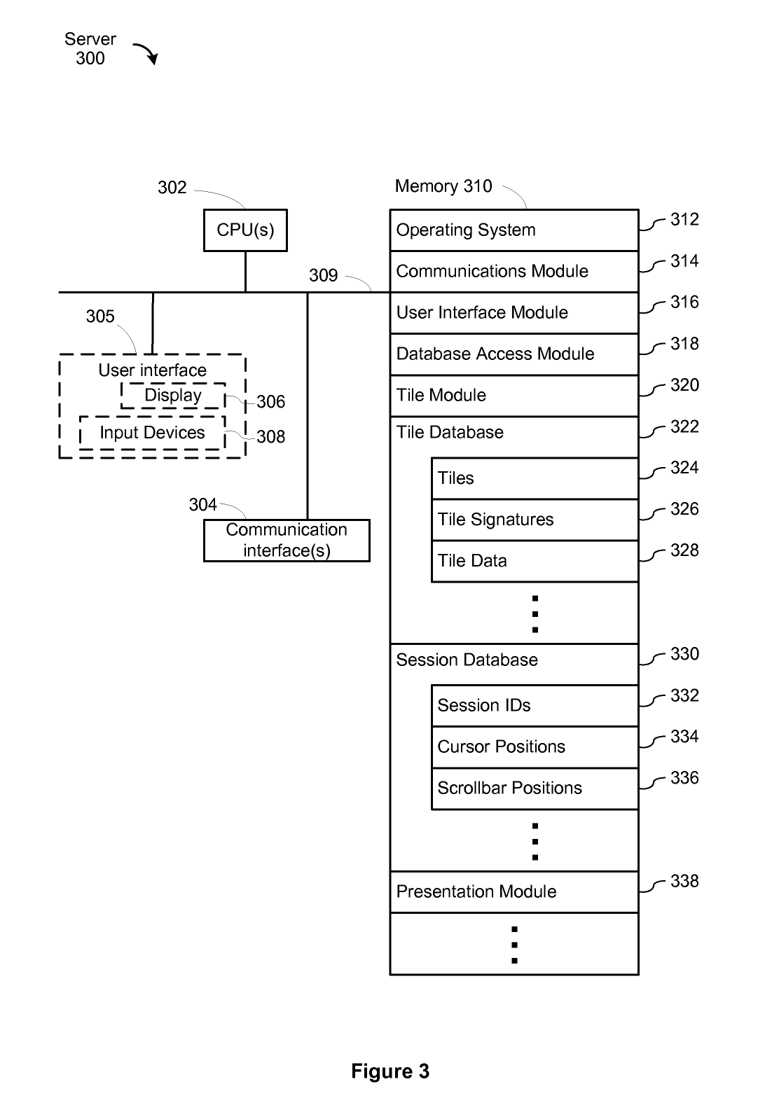

FIG. 3 is a block diagram illustrating a server 300, according to some embodiments. The server 300 can be the server 104 in FIG. 1. The server 300 typically includes one or more processing units (CPU's) 302, one or more network or other communications interfaces 304, memory 310, and one or more communication buses 309 for interconnecting these components. The communication buses 309 may include circuitry (sometimes called a chipset) that interconnects and controls communications between system components. The server 300 also may optionally include a user interface 305 comprising a display device 306 and input devices 308 (e.g., keyboard, mouse, touch screen, keypads, etc.). Memory 310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 310 may optionally include one or more storage devices remotely located from the CPU(s) 302. Memory 310, or alternately the non-volatile memory device(s) within memory 310, comprises a computer readable storage medium. In some embodiments, memory 310 stores the following programs, modules and data structures, or a subset thereof:
an operating system 312 that includes procedures for handling various basic system services and for performing hardware dependent tasks;
a communication module 314 that is used for connecting the server 300 to other computer systems via the one or more communication interfaces 304 (wired or wireless) and one or more communication networks, such as the Internet, other wide area networks, local area networks, metropolitan area networks, and so on;
a user interface module 316 that receives commands from a user via the input devices 308 and generates user interface objects in the display device 306; and
a database access module 318 that interfaces with databases (e.g., locally or remotely via the communication interfaces 304);
a tile module 320 that receives tiles, tile signatures, and tile data from a presenter computer system (e.g., the presenter computer system 102 in FIG. 1), stores the tiles images, tile signatures, and tile data in a tile database 322, and broadcasts the tiles, tile signatures, and tile data to one or more client computer systems (e.g., the client computer systems 106 in FIG. 1), as described herein;
the tile database 322 that includes tiles 324, tile signatures 326, and tile data 328 (e.g., tile metadata, words and/or characters associated with tiles, bounding boxes for words and/or characters associated with tiles, multimedia content associated with tiles, timestamps associated with tiles, links associated with objects in tiles, etc.), as described herein;
a session database 330 that includes session IDs 332, cursor positions 334, and scrollbar positions 336, as described herein; and
a presentation module 338 (e.g., the JavaScript program or web browser extension that includes instructions for sharing web pages with client computer systems and/or for view web pages shared by a presenter computer system).

Although FIG. 3 shows a “server,” FIG. 3 is intended more as functional description of the various features which may be present in a set of servers 300 than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used and how features are allocated among them will vary from one implementation to another, and may depend in part on the amount of data traffic that the system must handle during peak usage periods as well as during average usage periods.

In some embodiments, the tile database 322 is located on a computer system that is separate and distinct from the server 300. In these embodiments, the server 300 uses the database access module 318 to access the tile database 322 via a network (e.g., the network 120 in FIG. 1). In some embodiments, the session database 330 is located on a computer system that is separate and distinct from the server 300. In these embodiments, the server 300 uses the database access module 318 to access the session database 330 via a network (e.g., the network 120 in FIG. 1). In some embodiments, the tile database 332 and the session database 330 are located remotely on the computer system.

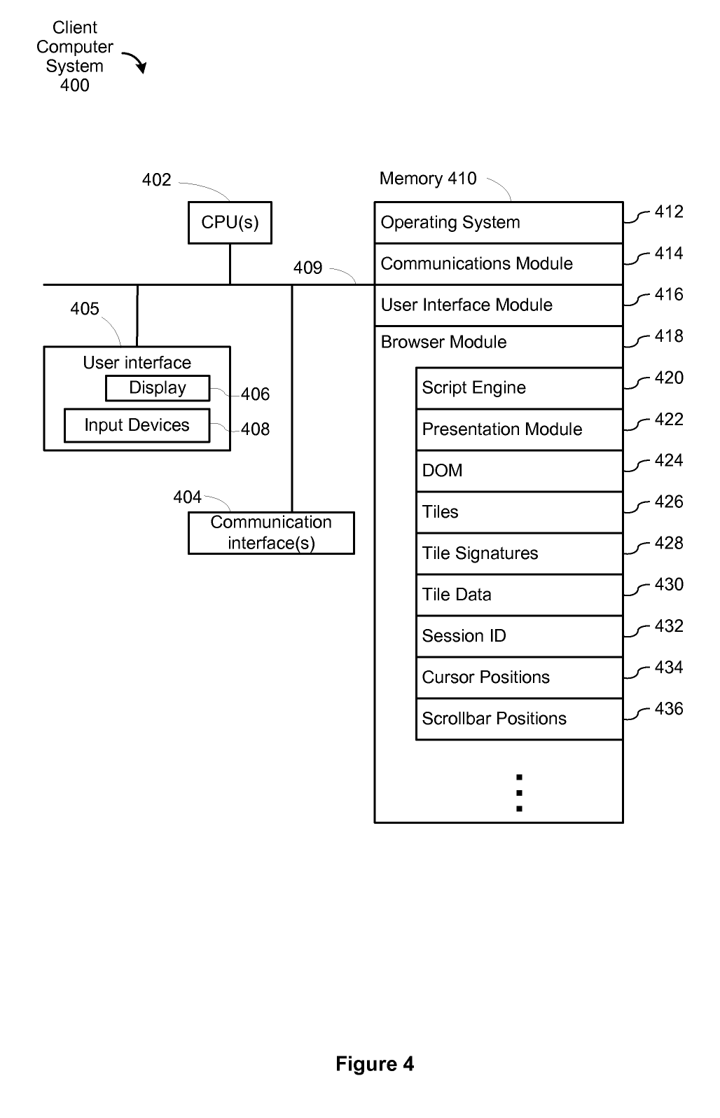

FIG. 4 is a block diagram illustrating a client computer system 400, according to some embodiments. The client computer system 400 can be any of the client computer systems 106 in FIG. 1. The client computer system 400 typically includes one or more processing units (CPU's) 402, one or more network or other communications interfaces 404, memory 410, and one or more communication buses 409 for interconnecting these components. The communication buses 409 may include circuitry (sometimes called a chipset) that interconnects and controls communications between system components. The client computer system 400 also includes a user interface 405 comprising a display device 406 and input devices 408 (e.g., keyboard, mouse, touch screen, keypads, etc.). Memory 410 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 410 may optionally include one or more storage devices remotely located from the CPU(s) 402. Memory 410, or alternately the non-volatile memory device(s) within memory 410, comprises a computer readable storage medium. In some embodiments, memory 410 stores the following programs, modules and data structures, or a subset thereof:
an operating system 412 that includes procedures for handling various basic system services and for performing hardware dependent tasks;
a communication module 414 that is used for connecting the client computer system 400 to other computers systems via the one or more communication interfaces 404 (wired or wireless) and one or more communication networks, such as the Internet, other wide area networks, local area networks, metropolitan area networks, and so on;
a user interface module 416 that receives commands from a user via the input devices 408 and generates user interface objects in the display device 406; and
a browser module 418 that includes a script engine 420 (e.g., a Java Virtual Machine, a JavaScript engine, an ActiveX engine, etc.) for executing scripts and/or programs (e.g., JavaScript programs, etc.), a presentation module 422 (e.g., the JavaScript program or web browser extension that includes instructions for viewing shared web pages from presenter computer systems), a document object model (DOM) 424 that includes an object model for representing a web page in to be displayed by the browser module 418 on the display device 406, tiles 426, tile signatures 428, tile data 430 (e.g., tile metadata, words and/or characters associated with tiles, bounding boxes for words and/or characters associated with tiles, multimedia content associated with tiles, timestamps associated with tiles, links associated with objects in tiles, etc.), a session ID 432, one or more cursor positions 434, and one or more scrollbar positions 436, as described herein.

Although FIG. 4 shows a “client computer system,” FIG. 4 is intended more as functional description of the various features which may be present in a client computer system than as a structural schematic of the embodiments described herein. In practice, and as recognized by those of ordinary skill in the art, items shown separately could be combined and some items could be separated.

Each of the above identified elements in FIGS. 2-4 may be stored in one or more of the previously mentioned memory devices, and corresponds to a set of instructions for performing a function described above. The set of instructions can be executed by one or more processors (e.g., the CPUs 202, 302, 402, respectively). The above identified modules or programs (i.e., sets of instructions) need not be implemented as separate software programs, procedures or modules, and thus various subsets of these modules may be combined or otherwise re-arranged in various embodiments. In some embodiments, memory 210, 310, and 410, respectively, may store a subset of the modules and data structures identified above. Furthermore, memory 210, 310, and 410, respectively, may store additional modules and data structures not described above.

### Capturing and Sharing Web Pages

In some embodiments, prior to sharing a web page with one or more subscribers, a presenter on a presenter computer system first starts a session on a server. FIG. 5 is a flowchart of a method 500 for starting a session to share web pages, according to some embodiments. A presenter computer system 502 (e.g., the presenter computer system 102 in FIG. 1) and a server 504 (e.g., the server 104 in FIG. 1) perform the operations illustrated in FIG. 5. In some embodiments, the presenter computer system 502 and the server 504 are separate and distinct from each other. In some embodiments, the presenter computer system 502 and the server 504 are located on the same system. In some embodiments, the operations performed by the presenter computer system 502 are performed by a browser module (e.g., the browser module 218 in FIG. 2) of the presenter computer system 502. In some embodiments, the operations performed by the server 504 are performed by a tile module (e.g., the tile module 320 in FIG. 3) of the server 504.

The presenter computer system 502 transmits (506) a request for a new session to the server 504. The server 504 receives (508) the request and creates (510) a new session. In some embodiments, the server 504 creates the new session by generating a session ID and storing the session ID in a session database (e.g., the session database 330 in FIG. 3). The server 504 then transmits (512) the session ID and a session URL that client computer systems may access to receive the shared web page. In some embodiments, the server 504 conditionally transmits the presentation program to the presenter computer system 502. For example, the server 504 transmits the presentation program to the presenter computer system 502 only if the presenter computer system 502 does not already possess the presentation program.

The presenter computer system 502 receives (514) the session ID and a session URL that client computer systems may access to receive the shared web page, and publishes (516) the session URL to subscribers (e.g., the subscribers 107 in FIG. 1). For example, the presenter computer system 502 may send an email or instant message including the session URL to the subscribers. Alternatively, or additionally, the presenter computer system 502 and/or the server 504 may publish the URL on a website. In some embodiments, the presenter computer system 502 also receives the presentation program and installs and/or executes the presentation program.

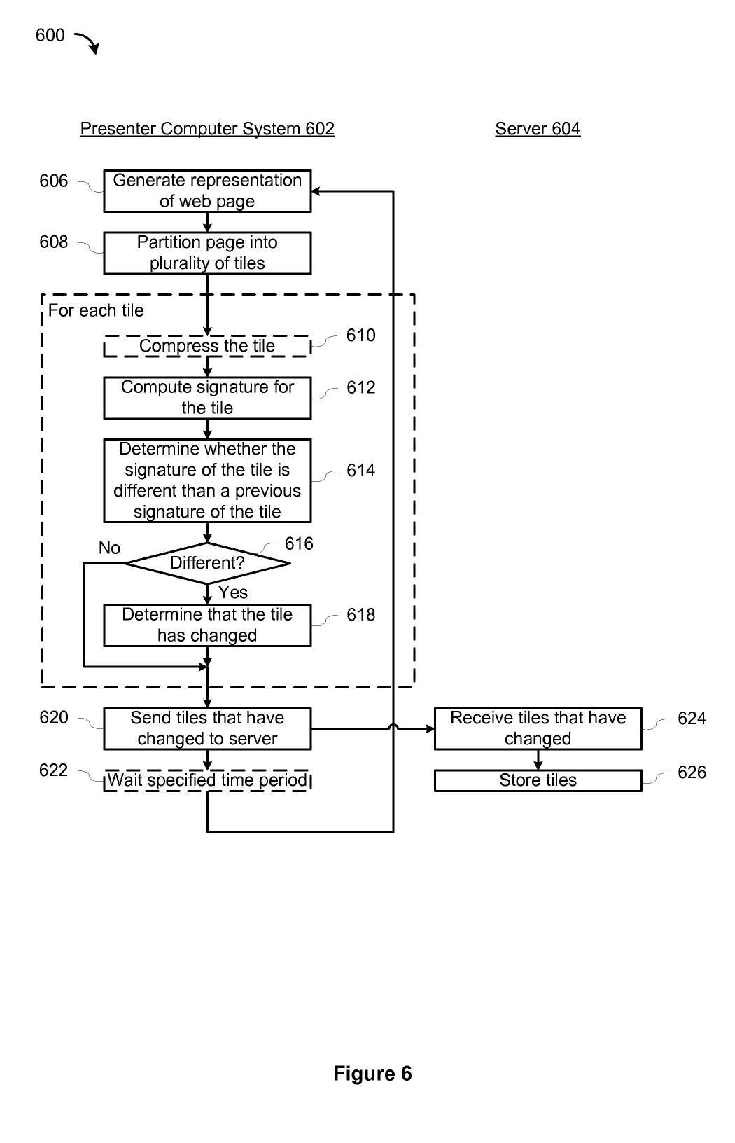

FIG. 6 is a flowchart of a method for sharing a web page, according to some embodiments. A presenter computer system 602 (e.g., the presenter computer system 102 in FIG. 1) and a server 604 (e.g., the server 104 in FIG. 1) perform the operations illustrated in FIG. 6. In some embodiments, the presenter computer system 602 and the server 604 are separate and distinct from each other. In some embodiments, the presenter computer system 602 and the server 604 are located on the same system. In some embodiments, the operations performed by the presenter computer system 602 are performed by a presentation module (e.g., the presentation module 222 in FIG. 2) executing within a script engine of a browser module (e.g., the script engine 220 of the browser module 218 in FIG. 2) of the presenter computer system 602. In some embodiments, the operations performed by the server 604 may be performed by a tile module (e.g., the tile module 320 in FIG. 3) of the server 604.

In some embodiments, a presenter using the presenter computer system 602 shares web pages displayed in one or more windows of a web browser of the presenter computer system 602. In these embodiments, web pages displayed in the one or more shared windows are shared with subscribers on client computer systems (e.g., the subscribers 107 on the client computer systems 106 in FIG. 1). In some embodiments, if there are two or more shared windows, the shared window that is actively being displayed in the web browser (e.g., the shared window with focus) is shared with the subscribers. In these embodiments, if the presenter switches to another shared window, the other shared window is shared with the subscribers. In some embodiments, if there are two or more shared windows, the contents of the two or more shared windows are shared concurrently. For example, if there are four shared windows on the presenter computer system 602, a client computer system spawns four web browser windows on the client computer system, where each browser window receives a corresponding shared web page. When the presenter switches between shared windows, the client computer system switches to the active shared window. In some embodiments, if the presenter switches to a window that is not shared, the shared window that was displayed most recently is shared with the subscribers.

Some web browsers support tabbed browsing. Thus, in some embodiments, the presenter selects one or more tabs in one or more windows of a web browser to be shared with subscribers on client computer systems (e.g., the subscribers 107 on the client computer systems 106 in FIG. 1). In these embodiments, web pages displayed in the one or more shared tabs are shared with the subscribers. In some embodiments, if there are two or more shared tabs, the shared tab that is actively being displayed in the web browser is shared with the subscribers. If the presenter switches to another shared tab, the other shared tab is shared with the subscribers. In some embodiments, if there are two or more shared tabs, the contents of the two or more shared tabs are shared concurrently. For example, if there are three shared tabs in a first window of the web browser and one shared tab in a second window of the web browser on the presenter computer system 602, a client computer system spawns three web browser tabs in a first window of a web browser and one shared tab in a second window on the client computer system, where each tab receives a corresponding shared tab. When the presenter switches between shared tabs, the client computer system switches to the active shared tab. In some embodiments, if the presenter switches to a tab that is not shared, the shared tab that was displayed most recently is shared with the subscribers.

The presenter computer system 602 generates (606) a representation of a web page that is displayed in a window of a web browser in a user interface of the presenter computer system 602. In some embodiments, the representation of the web page is an image of the web page. In some embodiments, the image of the web page is a bitmap image of the web page. In some embodiments, the image of the web page is an image format that is supported by web browsers. For example, the image of the web page may be a JPEG image, a GIF image, a TIFF image, a PNG image, etc.

The presenter computer system 602 partitions (608) the representation of the web page into a plurality of tiles based on a document object model of the web page. For example, if the representation of the web page is a bitmap image of the web page, the presenter computer system 602 partitions the bitmap image of the web page into a plurality of tiles, wherein a respective tile in the plurality of tiles is a bitmap image of a respective portion of the bitmap image of the web page. Note that other representations of the web page (e.g., JPEG, GIF, etc.) may be used.

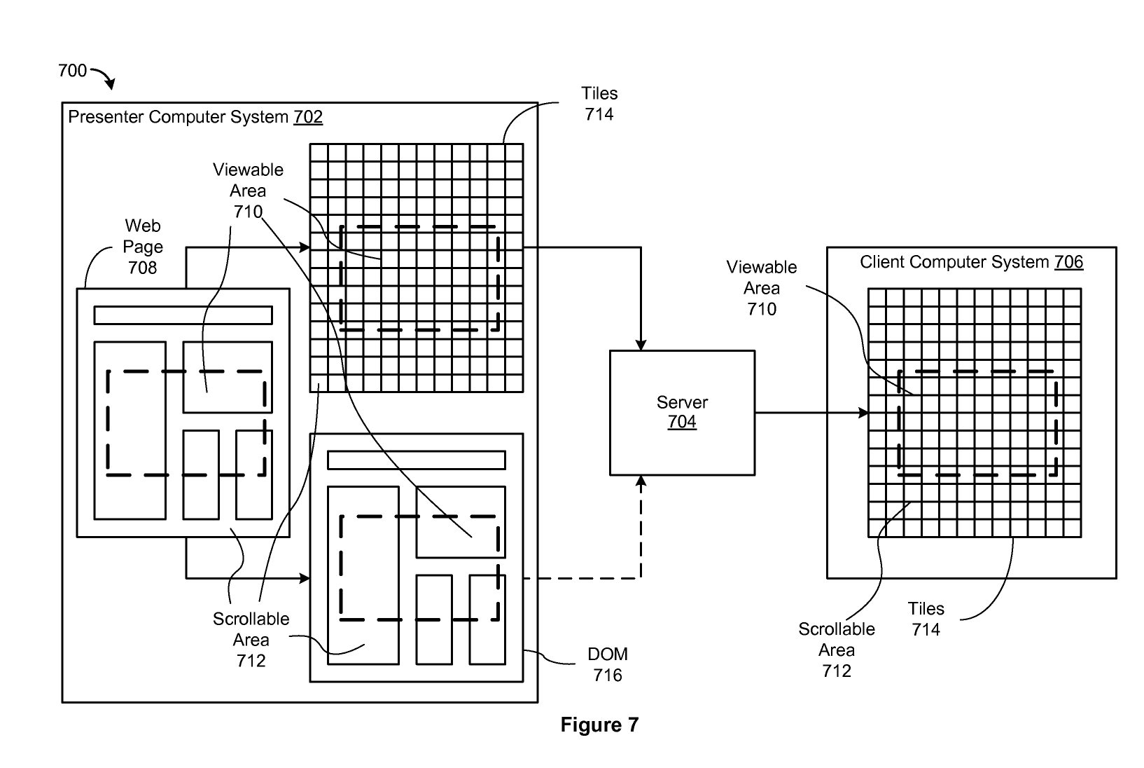

Attention is now directed to FIG. 7, which is a block diagram 700 illustrating a web page 708 that is displayed in a presenter computer system 702. The web page 708 may be displayed in a window and/or a tab of a web browser of the presenter computer system 702. The extent of the viewable area of the window and/or the tab of the web browser of the presenter computer system 702 is indicated by the dashed rectangle. The area of the web page 708 that is inside of the dashed rectangle is a viewable area 710 (e.g., it is rendered in the web browser window and/or tab). The area of the web page 708 that is outside of the dashed rectangle is a scrollable area 712 (e.g., it is not rendered in the web browser window and/or tab, but is accessible by using scrollbars to scroll the web page). Note that the viewable area 710 of the web page 708 is the area of the web page 708 that is rendered in a shared window and/or a shared tab of the web browser of the presenter computer system 702. If the web browser includes more than one shared window or shared tab, the viewable area 710 the web page 708 is the area of the web page 708 that would be rendered in the shared window and/or the shared tab of the web browser if the shared window and/or shared tab is active (or has focus) in the user interface of the presenter computer system 702.

The presenter computer system 702 also produces a document object model (DOM) 716 of the web page 708. The DOM 716 is typically produced by a layout engine of a web browser of the presenter computer system 702. In some embodiments, the presenter computer system 702 transmits the DOM 716 to a server 704.

As discussed above, the presenter computer system 702 generates a representation of the web page 708 and partitions the representation of the web page 708 into a plurality of tiles 714. At least subset of the plurality of tiles 714 is sent to the server 704, which in turn sends the subset of the plurality of tiles 714 to a client computer system 706, as described herein.

In some embodiments, the presenter computer system 702 partitions the representation of the web page 708 into the plurality of tiles 714 based on the DOM 716 of the web page 708 by determining the viewable area 710 of the web page 708 based on the DOM 716 and partitioning the viewable area 710 of the web page 708 into the plurality of tiles 714. Thus, in these embodiments, the presenter computer system 702 only partitions the representation of the web page 708 in the viewable area 710. Accordingly, if the presenter scrolls the web page 708 so that the viewable area 710 includes content of the web page 708 not previously rendered in the viewable area 710, the presenter computer system 702 needs to generate and send a new set of tiles to the server 704 for the new content in the viewable area 710.

In some embodiments, the presenter computer system 702 partitions the representation of the web page 708 into the plurality of tiles 714 based on the DOM 716 of the web page 708 by determining the viewable area 710 of the web page 708 based on the DOM 716, determining the scrollable area 712 of the web page 708 based on the DOM 716, and partitioning the viewable area 710 and the scrollable area 712 of the web page 708 into the plurality of tiles 714. Thus, in these embodiments, the presenter computer system 702 partitions the representation of the whole web page 708. Accordingly, if the presenter scrolls the web page 708 so that the viewable area 710 includes content of the web page 708 not previously rendered in the viewable area 710 and the content of the web page 708 has not changed since the previously-generated representation of the web page 708 was generated, the presenter computer system 702 does not need to generate and send a new set of tiles to the server 704 because the tiles 714 at the server 704 are still valid. The presenter computer system 702 only needs to send information about the scrollbar positions so that the client computer system 706 can display the corresponding tiles (or portions of tiles) in the viewable area 710. If the content of the web page 708 has changed since the previously-generated representation of the web page 708 was generated, the presenter computer system 702 generates a new representation of the web page 708 and partitions the representation of the web page 708 as described herein.

In some embodiments, the presenter computer system 702 partitions the representation of the web page 708 into the plurality of tiles 714 based on the DOM 716 of the web page 708 by determining the viewable area 710 of the web page based on the DOM 716, determining the scrollable area 712 of the web page 708 based on the DOM 716, and partitioning the viewable area 710 and a subset of the scrollable area 712 of the web page 708 into the plurality of tiles 714. Thus, in these embodiments, the presenter computer system 702 only partitions the representation of the web page 708 in the viewable area 710 and a portion of the scrollable area 712. Accordingly, if the presenter scrolls the web page 708 so that (1) the viewable area 710 includes content of the web page 708 not previously rendered in the viewable area 710, (2) the content of the web page 708 has not changed since the previously-generated representation of the web page 708 was generated, and (3) the content of the web page 708 not previously rendered in the viewable area 710 is included in the subset of the scrollable area 712 of the web page 708, the presenter computer system 702 does not need to generate and send a new set of tiles to the server 704 because the tiles 714 at the server 704 are still valid. The presenter computer system 702 only needs to send information about the scrollbar positions so that the client computer system 706 can display the corresponding tiles (or portions of tiles) in the viewable area 710. If the content of the web page 708 has changed since the previously-generated representation of the web page 708 was generated or if the web page 708 not previously rendered in the viewable area 710 is not included in the subset of the scrollable area 712, the presenter computer system 702 generates a new representation of the web page 708 and partitions the representation of the web page 708 as described herein.

In some embodiments, the viewable area includes portions of tiles. In these embodiments, any tile that is included in the viewable area is sent to the server 704.

Returning to FIG. 6, in some embodiments, the presenter computer system 602 compresses the tiles in the plurality of tiles. In these embodiments, for each tile in the plurality of tiles, the presenter computer system 602 compresses (610) the tile to produce a compressed tile. In some embodiments, the presenter computer system 602 compresses the tile by converting the tile to a JPEG representation of the tile. In some embodiments, the presenter computer system 602 compresses the tile by converting the tile to a PNG representation of the tile. In some embodiments, the presenter computer system compresses the tile by applying a file compression technique to the tile (e.g., gzip, etc.). In some embodiments, the presenter computer system 602 compresses the tile using a number of compression techniques (e.g., image compression and file compression, etc.) and selects a compressed tile that has the smallest file size. The presenter computer system 602 then determines whether the tile has changed relative to a previous version of the tile. In some embodiments, the presenter computer system 602 determines (614) whether the tile has changed relative to the previous version of the tile as follows. The presenter computer system 602 computes (612) a signature of the compressed tile. In some embodiments, the presenter computer system 602 computes the signature of the compressed tile by computing a hash value of the compressed tile using a hash function. For example, the presenter computer system uses a MD5 hashing function to generate a hash value of the compressed tile. The presenter computer system 602 then determines (614) whether the signature of the compressed tile is different than a previously computed signature of the previous version of the compressed tile. In response to determining that the signature for the compressed tile is different than the previously computed signature of the previous version of the compressed tile (616, yes), the presenter computer system determines (618) that the compressed tile has changed.

In some embodiments, the presenter computer system 602 partitions (608) the web page into the plurality of tiles and leaves the tiles in an uncompressed form. In these embodiments, for each tile in the plurality of tiles, the presenter computer system 602 determines whether the tile has changed relative to the previous version of the tile as follows. The presenter computer system 602 computes (612) a signature of the tile. The presenter computer system 602 then determines (614) whether the signature of the tile is different than a previously computed signature of the previous version of the tile. In some embodiments, the presenter computer system 602 computes the signature of the compressed tile by computing a hash value of the compressed tile using a hash function. For example, the presenter computer system uses a MD5 hashing function to generate a hash value of the compressed tile. In response to determining that the signature for the tile is different than the previously computed signature of the previous version of the tile (616, yes), the presenter computer system 602 determines (618) that the tile has changed. In some embodiments, the presenter computer system 602 marks the tiles that have changed so that the presenter computer system 602 can send the tiles marked as changed to the server 604.

After step 618 or in response to determining that the signature for the tile is not different than the previously computed signature of the previous version of the tile (616, no), the presenter computer system 602 sends (620) tiles that have changed to the server 604. In some embodiments, if the presenter computer system 602 compressed the tiles, the presenter computer system 602 sends the compressed tiles to the server 604. In some embodiments, if the presenter computer system 602 did not compress the tiles, the presenter computer system 602 sends the uncompressed tiles to the server 604. In some embodiments, the presenter computer system 602 always sends compressed tiles to the server 604.

In some embodiments, the presenter computer system 602 sends the tiles to the server 604 as the tiles are processed. For example, the presenter computer system 602 sends the tiles to the server 604 for each iteration of the steps 610-618. In some embodiments, the presenter computer system 602 sends the tiles to the server 604 in batches. For example, the presenter computer system 602 may send the tiles to the server 604 at the end of each iteration of steps 610-618. Similarly, the presenter computer system 602 may send the tiles to the server 604 after a specified interval (e.g., after a specified time period or number of iterations) has occurred.

In some embodiments, if the presenter computer system 602 generated a compressed tile, the presenter computer system 602 sends the signature of the compressed tile to the server. In some embodiments, if the presenter computer system 602 generated an uncompressed tile, the presenter computer system 602 sends the signature of the uncompressed tile to the server.

In some embodiments, in response to determining that the tile has changed, the presenter computer system 602 generates a timestamp corresponding to a time when the tile was generated and sends the timestamp to the server.

A tile may change and return to its original value (e.g., representation). For example, a tile may have a first value at t=0, a second value at t=1, and return to the first value at t=4. Furthermore, two distinct tiles may have the same values. For example, a web page may have a uniform background (e.g., a white background) across a number of tiles. In both of these cases, it is inefficient for the presenter computer system 602 to send a duplicate copy of the tile to the server 604 if the server 604 already received the tile in the past. Similarly, it is inefficient for the presenter computer system 602 to send copies of the same tile representation to the server 602. Thus, in some embodiments, the presenter computer system 602 maintains a list of signatures of tiles that have been sent to the server 604. Note that these embodiments apply both to compressed and uncompressed tiles (as described above). In some embodiments, the presenter computer system 602 compares a current signature of a tile with a previous signature of the tile (e.g., all previous signatures of the tile or the immediately prior signature of the tile) in the list of tiles to determine (614) whether the signature of the tile is different than a previous signature of the tile. In some embodiments, the presenter computer system 602 compares a current signature of a tile with signatures of all tiles (e.g., across the whole web page, etc.) in the list of tiles that have been sent to the server 604 to determine (614) whether the signature of the tile is different than a previous signature of the tile. In either of these embodiments, if presenter computer system 602 determines that the tile has changed and the tile has been previously sent to the server, the presenter computer system only sends an identifier of the tile (e.g., a signature of the tile, or a tile name, a unique identifier of a tile, etc.) to the server 604. When a client computer system receives the identifier of the tile, the client computer system displays the tile corresponding to the identifier of the tile. If the client computer system does not have a copy of the tile, the client computer system may request the tile from the server 604.

The presenter computer system 602 then waits (622) for a specified time period then returns to step 606.

After step 620, the server 604 then receives (624) tiles that have changed and stores (626) the tiles in a tile database (e.g., the tile database 322 in FIG. 3). In some embodiments, the server 604 stores all versions of the tiles received from the presenter computer system 602. In some embodiments, the server 604 stores a subset of the versions of the tiles received from the presenter computer system 602. In both of these embodiments, the server 604 maintains a time-ordered list of tiles so that the sequence of tiles may be displayed in order during future playback. In some embodiments, the server 604 stores only the most recent version of the tile received from the presenter computer system 602.

In some embodiments, a respective tile includes metadata. In some embodiments, the metadata includes a name of the respective tile, a position of the respective tile in the web page, and a timestamp indicating a time when the respective tile was generated. In these embodiments, the presenter computer system 602 sends the metadata along with the tile to be stored in the tile database.

In some embodiments, the presenter computer system 602 determines session data and sends the session data to the server. In some embodiments, the session data includes a session identifier, a height of second window, a width of second window, a scrollable height of the web page, a scrollable width of the web page, a vertical position of a vertical scroll bar, a horizontal position of a horizontal scroll bar, and a cursor shape.

In some embodiments, the presenter computer system 602 records audio played on the presenter computer system and send the audio to the server. The presenter computer system 602 also generates a timestamp for the time when the audio is recorded so that the audio can be synchronized with the screencast.

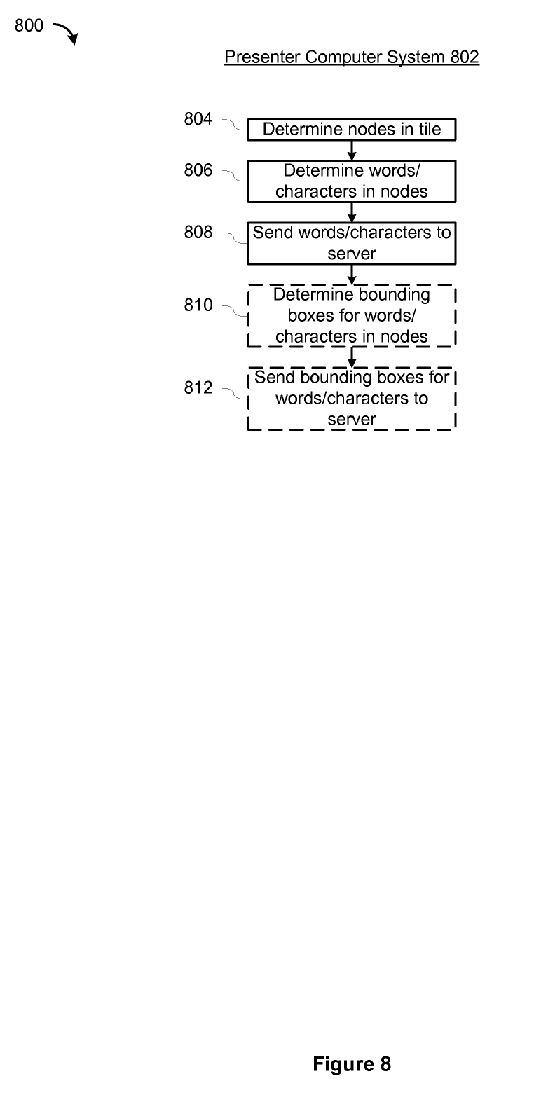

In some embodiments, a presenter computer system sends words and/or characters in a respective tile to a server. FIG. 8 is a flowchart of a method 800 for determining words and/or characters that are in a tile, according to some embodiments. A presenter computer system 802 (e.g., the presenter computer system 102 in FIG. 1) performs the operations illustrated in FIG. 8. In some embodiments, the operations performed by the presenter computer system 802 are performed by a presentation module (e.g., the presentation module 222 in FIG. 2) executing within a script engine of a browser module (e.g., the script engine 220 of the browser module 218 in FIG. 2) of the presenter computer system 802.

The presenter computer system 802 queries (804) the document object model of the web page to determine nodes of the web page that are within each tile. The presenter computer system 802 then determines (806) words and/or characters in the nodes based on the document object model. For example, the presenter computer system 802 obtains the accessible interface for these nodes (e.g., nsIAccessibleText in Mozilla Firefox), and then goes through each word and/or character to obtain its value. The presenter computer system 802 sends (808) the words and/or characters to a server (e.g., the server 104 in FIG. 1). In some embodiments, the words and/or characters are sent with the tile and stored on the server.

In some embodiments, the presenter computer system 802 also determines (810) bounding boxes for the words and/or characters in the nodes based on the document object model and sends (812) the bounding boxes to the server. For example, the presenter computer system 802 obtains the accessible interface for these nodes (e.g., nsIAccessibleText in Mozilla Firefox), and then goes through each word and/or character to obtain its bounding box. In some embodiments, the bounding boxes for the words and/or characters and the words and/or characters are sent with the tile and stored on the server.

In some embodiments, timestamps are generated for the words and/or characters and/or the bounding boxes for the words and/or the characters at the time the DOM is queried. These timestamps are sent to the server along with the tile. Subscribers can then search the screencast for the occurrence of a particular word within a particular timeframe.

In some embodiments, a filter is applied to the words and/or characters to filter out words and/or characters based on specified conditions. For example, a privacy filter may filter out email addresses, social security numbers, phone numbers, street addresses, etc. In some embodiments, the presenter computer system 802 applies the filter prior to sending the words and/or characters to the server. In some embodiments, the server applies the filters on words and/or characters received from the presenter computer system 802. Note that optical character recognition (OCR) techniques may be used. However, OCR techniques may produce false negatives (e.g., OCR may miss the “@” symbol and skip an email address). These embodiments are beneficial because the actual words and/or characters are available via the DOM. Thus, the filter does not suffer the same problems as OCR techniques.

In some embodiments, the presenter computer system 802 obtains and sends, to the server, links for objects in the web page that include links. For example, the presenter computer system 802 queries the DOM for objects (e.g., text, multimedia objects, etc.) on the shared web page that are associated with links (e.g., URLs). The presenter computer system 802 then sends links to the server. A client computer system (e.g., any of the client computer systems 106) positions the links at corresponding positions in the shared web page displayed on the client computer system. Thus, subscribers can click on the links as they are viewing a screencast.

In some embodiments, since the embodiments described herein have access to the DOM for the web page, other document objects may be obtained and shared. For example, information about HTML FORM elements (e.g., input boxes of forms), HTML IMG elements, paragraph positions, types of multimedia objects, etc. may be shared. Thus, a subscriber may search for a screencast that includes specified words and video clips.

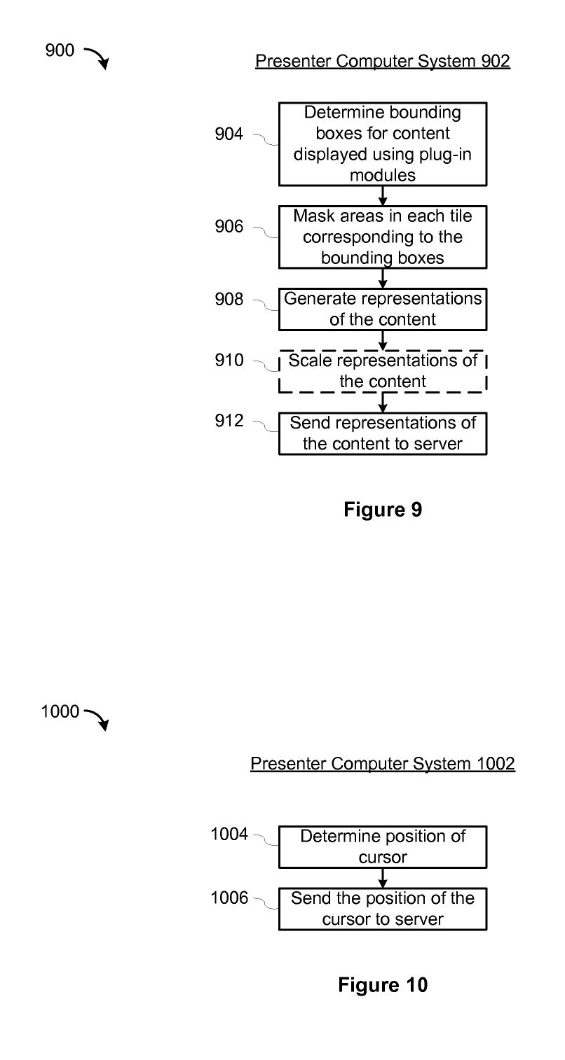

FIG. 9 is a flowchart of a method 900 for handling content that is displayed using plug-in modules of a web browser, according to some embodiments. For example, the plug-in modules may include a movie plug-in module (e.g., Adobe Flash, Windows Media Player, Apple Quicktime, etc.). A presenter computer system 902 (e.g., the presenter computer system 102 in FIG. 1) performs the operations illustrated in FIG. 9. In some embodiments, the operations performed by the presenter computer system 902 are performed by a presentation module (e.g., the presentation module 222 in FIG. 2) executing within a script engine of a browser module (e.g., the script engine 220 of the browser module 218 in FIG. 2) of the presenter computer system 902.

The presenter computer system 902 queries (904) the document object model of the web page to determine bounding boxes for content within each tile of the plurality of tiles, wherein the content is displayed using plug-in modules of the web browser. The presenter computer system 902 then masks (906) areas in each tile corresponding to the bounding boxes. The presenter computer system 902 generates (908) representations of the content. In some embodiments, the presenter computer system 902 scales (910) the representations of the content. The presenter computer system 902 then sends (912) the representations of the content and the bounding boxes to the server.

In some embodiments, the presenter computer system 902 sends a description of a respective plug-in module type (e.g., Apple Quicktime, Adobe Flash, Microsoft Windows Media Player, etc.) and/or a respective link corresponding to the content that is displayed using the respective plug-in module to the server. In these embodiments, a client computer system loads the respective plug-in module and renders the content using the respective plug-in module at the location of the bounding box for the content.

FIG. 10 is a flowchart of a method 1000 for sharing a position of a cursor in a shared web page, according to some embodiments. A presenter computer system 1002 (e.g., the presenter computer system 102 in FIG. 1) performs the operations illustrated in FIG. 10. In some embodiments, the operations performed by the presenter computer system 1002 are performed by a presentation module (e.g., the presentation module 222 in FIG. 2) executing within a script engine of a browser module (e.g., the script engine 220 of the browser module 218 in FIG. 2) of the presenter computer system 1002.

The presenter computer system 1002 determines (1004) a position of a cursor in the shared web page and sends (1006) the position of the cursor to the server.

In some embodiments, the presenter computer system 1002 periodically determines the position of the cursor in the shared web page. If the position of the cursor has changed since the previous position, the presenter computer system 1002 sends the position of the cursor to the server and a timestamp indicating the time at which the position of the cursor was sent to the server. If the position of the cursor has not changed since the previous position, the presenter computer system 1002 does not send the position of the cursor to the server.

In some embodiments, a client computer system (e.g., any of the client computer systems 106) sends a position of a cursor in the shared web page displayed on the client computer system to the presenter computer system 1002. In these embodiments, the presenter computer system 1002 displays the position of the cursor of the client computer system in the shared web page displayed on the presenter computer system 1002. In some embodiments, the presenter computer system 1002 shares the cursor of the client computer system in the shared web page (e.g., shares with other computer systems). In some embodiments, the client computer system interacts with objects displayed on the shared web page on the presenter computer system 1002 using the cursor of the client computer system. For example, the client computer system may click a link on the shared web page and cause the presenter computer system 1002 to load a web page corresponding to the clicked link.

In some embodiments, the presenter computer system 1002 receives keyboard inputs from the client computer system. The presenter computer system 1002 then displays the keyboard inputs on the shared web page. In some embodiments, the presenter computer system 1002 shares the keyboard inputs of the client computer system in the shared web page (e.g., shares with other computer systems). Thus, these embodiments allow the client computer system 1202 to interact with the presenter computer system.

### Displaying Shared Web Pages

In some embodiments, a shared web page is broadcast in real-time. In these embodiments, a client computer system subscribes to a shared web page to receive the real-time broadcast. In some embodiments, a shared web page is recorded and stored on a server for subsequent playback. In these embodiments, the client computer system obtains the recorded version of the shared web page from the server.

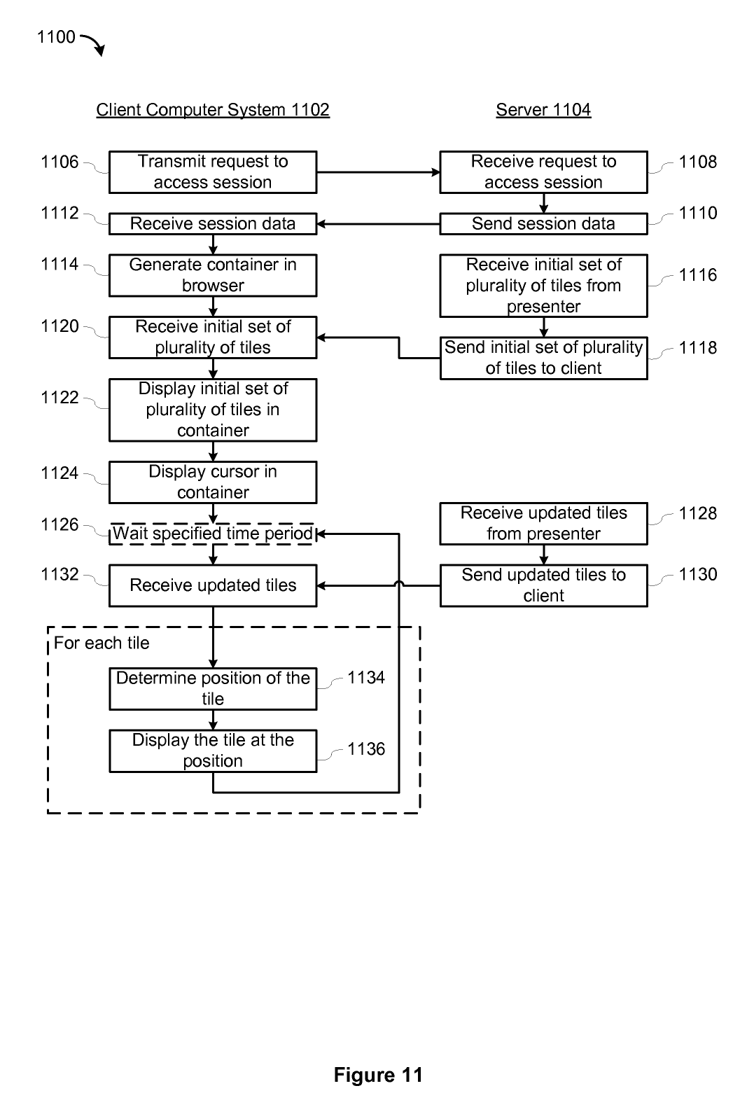

FIG. 11 is a flowchart of a method 1100 for displaying a shared web page, according to some embodiments. A client computer system 1102 (e.g., any of the client computer system 106 in FIG. 1) and a server 1104 (e.g., the server 104 in FIG. 1) perform the operations illustrated in FIG. 11. In some embodiments, the operations performed by the client computer system 1102 are performed by a presentation module (e.g., the presentation module 422 in FIG. 4) executing within a script engine of a browser module (e.g., the script engine 420 of the browser module 418 in FIG. 4) of the client computer system 1102. In some embodiments, the operations performed by the server 1104 may be performed by a tile module (e.g., the tile module 320 in FIG. 3) of the server 1104.

The client computer system 1102 transmits (1106) a request to access a session to the server 1104. In some embodiments, the request generated in response to receiving a session URL from a presenter computer system (e.g., step 516 in FIG. 5). The server 1104 receives (1108) the request to access the session and sends (1110) the session data to the client computer system 1102. In some embodiments, the session data includes: a session identifier, a height of the second window, a width of the second window, a scrollable height of the web page, a scrollable width of the web page, a vertical position of a vertical scroll bar, a horizontal position of a horizontal scroll bar, and a cursor shape.

In some embodiments, the server 1104 sends a program including instructions for the presentation module to the client computer system 1102. In these embodiments, the client computer system 1102 receives the program and installs and/or executes the program. In some embodiments, the server 1104 does not send the program because the client computer system 1102 already has the program. In these embodiments, the client computer system 1102 executes the program.

The client computer system 1102 receives (1112) the session data and generates (1114) a container within a window and/or a tab of the web browser based on the session data. In some embodiments, the client computer system 1102 creates a first container having a size of the viewable area of the shared web page. The client computer system 1102 then creates a second container within the first container, the second container having a size of the scrollable area. Since the scrollable area is typically larger than the viewable area, web browser of the client computer system 1102 automatically creates scrollbars for the first container so that the user can scroll the content included in the second (larger) container. In some embodiments, the first container and the second container are HTML DIV elements.

The server 1104 receives (1116) an initial set of tiles from the presenter computer system and sends (1118) the initial set of tiles to the client computer system 1102.

The client computer system 1102 receives (1120) the initial set of tiles from the server 1104. The client computer system 1102 then displays (1122) at least a subset of the initial set of tiles in the container in the window and/or tab of the web browser and displays (1124) a cursor in the window and/or tab of the web browser based on the session data. In some embodiments, the client computer system 1102 displays the cursor using the cursor shape included in the session data. If the tiles are compressed using a file compression technique (e.g., gzip, etc.), the client computer system 1102 uncompresses the tiles before displaying the tiles. If the tiles are compressed using an image compression technique (e.g., JPEG compression, etc.), the client computer system 1102 uses the appropriate image decoder prior to displaying the tiles.

The client computer system 1102 waits (1126) a specified time period.

The server 1104 periodically receives (1128) updated tiles from the presenter and sends (1130) the updated tiles to the client computer system 11102.

The client computer system receives (1132) updated tiles from the server 1104. For each updated tile, the client computer system 1102 determines (1134) a position of the tile within the web page and displays (1136) the tile at the position within a window and/or a tab of the web browser in the user interface of the client computer system 1102. In some embodiments, the client computer system 1102 determines the position of the tile based on the metadata for the tile.

After all of the update tiles have been processed, the client computer system 1102 returns to step 1126.

Note that as described above, in steps 1120-1122 and steps 1132-1136, the server 1104 periodically “pushes” the tiles to the client computer system 1102. Thus, the client computer system 1102 and the server 1104 maintain a persistent connection throughout the session. To do so, a dedicated port in the firewall must be opened.

In some embodiments, the client computer system 1102 periodically “pulls” updated tiles from the server 1104. For example, the client computer system 1102 periodically requests and receives updated session data, including a list of updated tiles and/or signatures for the tiles, from the server 1104. Based on the updated session data, the client computer system 1102 then requests and receives updated tiles that the client computer system 1102 does not already have from the server 1104. Since, the client computer system 1102 makes the requests to the server 1104, the client computer system 1102 and the server 1104 do not need to maintain a persistent connection throughout the session. Thus, the client computer system 1102 may use a standard port (e.g., TCP ports 80 and/or 443-standard HTTP and HTTPS ports, respectively). Accordingly, a dedicated port in a firewall does not need to be opened.

In some embodiments, the client computer system 1102 stores all versions of the tiles received from the server 1104. In some embodiments, the client computer system 1102 stores a subset of the versions of the tiles received from the server 1104. In some embodiments, the client computer system 1102 stores only the most recently received version of the tiles from the server 1104. In all of these embodiments, a tile-storage parameter set by a subscriber on the client computer system 1102 and/or a tile-storage parameter set by a presenter on a presenter computer system determines the amount of tiles that are or that may be stored on the client computer system 1102. For example, if the client computer system 1102 has limited memory, the client computer system 1102 may set the tile-storage parameter so that only the most recent versions of the tiles are stored on the client computer system 1102. Similarly, if the presenter does not want the client computer system 1102 to have a copy of the full screencast, the presenter may set the tile-storage parameter so that only the most recent versions of the tiles are stored on the client computer system 11102.

In some embodiments, the viewable area of the shared web page includes a portion of a tile. In these embodiments, the full tile is sent to the client computer system and only the portion of the tile that is in the viewable area of the shared web page is rendered and displayed.

In some embodiments, tiles for the whole shared web page are received. In some embodiments, the client computer system only displays the tiles (or portions of the tiles) that are in the viewable area of the web page. Since the client computer system has information about the whole shared web page, the subscriber can scroll the shared web page to view portions of the shared web page that are not in the viewable area.

In some embodiments, tiles for the viewable area and for a portion of the scrollable area of a shared web page are received. In these embodiments, the client computer system only displays the tiles (or portions of the tiles) that are in the viewable area of the web page. However, since, the client computer system has information about a portion of the scrollable area of the shared web page, the subscriber can scroll the shared web page to view the portions of the shared web page that are not in the viewable area, but that are in the portion of the scrollable area received by the client computer system.

In some embodiments, the client computer system 1102 also receives words and/or characters in each tile, bounding boxes for words and/or characters in each tile, bounding boxes and representations of the multimedia content that use browser plug-ins, links and corresponding positions of the links in each tile, or a combination thereof. The client computer system 1102 then renders these items in the viewable area of the web page. For example, any links that are in the viewable area of the web page are rendered so that the user can click on the link. If the user clicks on the link, a separate web browser window or tab is launched. Similarly, representations for multimedia content that require plug-in modules are rendered at the appropriate location in the viewable area.

In some embodiments, the client computer system 1102 receives the DOM for the shared web page. In these embodiments, the client computer system 1102 reproduces the structure of the web page using invisible DIV elements. Accordingly, user interface functions of the web browser of the client computer system 1102 that are based on the structural layout of web pages can be used. For example, on Apple's iPhone, a user can double-tap on a paragraph, an image, or other objects, and the web browser zooms into the corresponding area. Thus, a subscriber using the iPhone can double-tap on objects in the shared web page and the iPhone's web browser will zoom into the corresponding area of the shared web page.

In some embodiments, the client computer system 1102 scales the tiles to fit in a display device of the client computer system 1102.

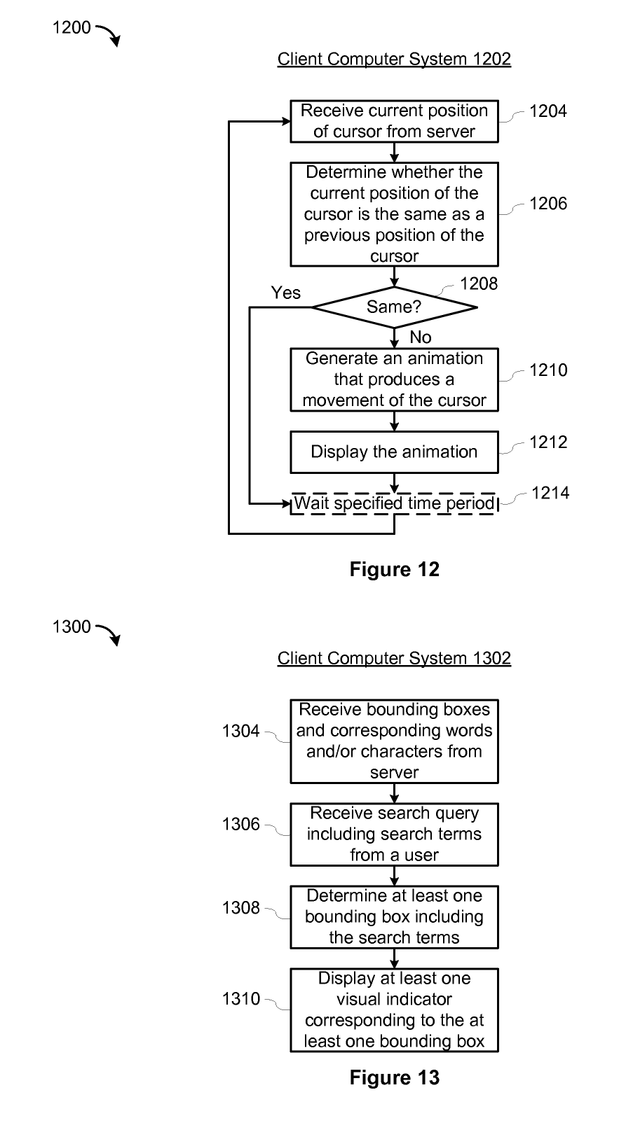

FIG. 12 is a flowchart of a method 1200 for displaying a position of a cursor in a shared web page, according to some embodiments. A client computer system 1202 (e.g., any of the client computer system 106 in FIG. 1) performs the operations illustrated in FIG. 12. In some embodiments, the operations performed by the client computer system 1202 are performed by a presentation module (e.g., the presentation module 422 in FIG. 4) executing within a script engine of a browser module (e.g., the script engine 420 of the browser module 418 in FIG. 4) of the client computer system 1202.

The client computer system 1202 receives (1204) a current position of a cursor from the server. In some embodiments, the client computer system 1202 only receives a current position of the cursor from the server if the current position of the cursor is different than the previous position of the cursor. In some embodiments, the client computer system 1202 periodically receives session data including a current cursor position from the server 1104.

The client computer system then determines (1206) whether the current position of the cursor is the same as a previous position of the cursor. In response to determining that the current position of the cursor is different than the previous position of the cursor (1208, no), the client computer system 1202 generates (1210) an animation that produces a movement of the cursor from the previous position of the cursor to the current position of the cursor and displays (1212) the animation in the window of the web browser of the client computer system 1202. For example, the client computer system 1202 may use an interpolation function to generate a smooth movement between the previous position of the cursor and the current position of the cursor.

After step 1212 or in response to determining that the current position of the cursor is the same as the previous position of the cursor (1208, yes), the client computer system 1202 waits (1214) a specified time period and returns to step 1204.

In some embodiments, the client computer system 1202 (e.g., any of the client computer systems 106) sends a position of a cursor in the shared web page displayed on the client computer system 1202 to the presenter computer system 1002. In these embodiments, a presenter computer system displays the position of the cursor of the client computer system 1202 in the shared web page displayed on the presenter computer system. In some embodiments, the presenter computer system shares the cursor of the client computer system 1202 in the shared web page (e.g., shares with other computer systems). In some embodiments, the client computer system 1202 interacts with objects displayed on the shared web page on the presenter computer system using the cursor of the client computer system 1202. For example, the client computer system 1202 may click a link on the shared web page and cause the presenter computer system to load a web page corresponding to the clicked link.

In some embodiments, the presenter computer system receives keyboard inputs from the client computer system 1202. The presenter computer system then displays the keyboard inputs on the shared web page. In some embodiments, the presenter computer system shares the keyboard inputs of the client computer system 1202 in the shared web page (e.g., shares with other computer systems). Thus, these embodiments allow the client computer system 1202 to interact with the presenter computer system.

FIG. 13 is a flowchart of a method 1300 for performing a search on a shared web page, according to some embodiments. A client computer system 1302 (e.g., any of the client computer system 106 in FIG. 1) performs the operations illustrated in FIG. 13. In some embodiments, the operations performed by the client computer system 1302 are performed by a presentation module (e.g., the presentation module 422 in FIG. 4) executing within a script engine of a browser module (e.g., the script engine 420 of the browser module 418 in FIG. 4) of the client computer system 1302.

The client computer system 1302 receives (1304) bounding boxes and corresponding words and/or characters from the server, wherein a respective bounding box corresponds to a specified location of a respective word and/or a respective character within a respective tile. The client computer system 1302 receives (1306) a search query including search terms from a user of the client computer system 1302. The client computer system 1302 then determines (1308) at least one bounding box including the search terms and displays (1310) at least one visual indicator corresponding to the at least one bounding box. For example, the client computer system 1302 may highlight the search term.

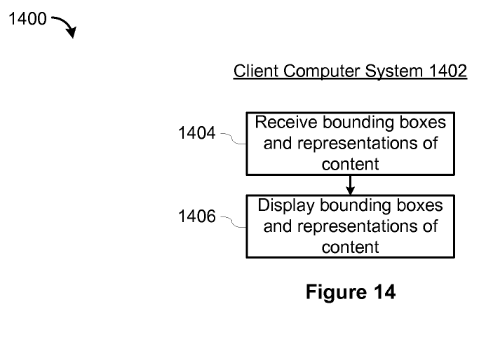

FIG. 14 is a flowchart of a method 1400 for displaying content that is displayed using plug-in modules of a web browser, according to some embodiments. A client computer system 1402 (e.g., any of the client computer system 106 in FIG. 1) performs the operations illustrated in FIG. 14. In some embodiments, the operations performed by the client computer system 1402 are performed by a presentation module (e.g., the presentation module 422 in FIG. 4) executing within a script engine of a browser module (e.g., the script engine 420 of the browser module 418 in FIG. 4) of the client computer system 1402.

The client computer system 1402 receives (1404) bounding boxes and representations of content that are displayed using plug-in modules of the web browser and displays (1404) the bounding boxes and the representations of the content in the window and/or tab of the web browser.

In some embodiments, the presenter computer system sends a description of a respective plug-in module type (e.g., Apple Quicktime, Adobe Flash, Microsoft Windows Media Player, etc.) and/or a respective link corresponding to the content that is displayed using the respective plug-in module to the server. In these embodiments, the client computer system 1402 loads the respective plug-in module and renders the content using the respective plug-in module at the location of the bounding box for the content.

### Embedded Screencast Player

In some embodiments, a screencast player for playing screencasts is embedded in a web page. For example, the screencast player may be embedded using an IFRAME or a DIV element of a web page (e.g., a blog, etc.). In some embodiments, subscribers search for and view screencasts using the screencast player embedded in the web page.

In some embodiments, a publisher allows text of a screencast to be searchable by a search engine. Thus, subscribers can search for screencasts using a keyword search.

In some embodiments, the screencast player allows presenters and/or users to link to a specific segment of a screencast. Thus, the presenters and/or users may share specific parts of screencasts. Similarly, the presenters and/or users may produce aggregates (e.g., mashups, etc.) of parts coming from different screencasts.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for sharing web pages, comprising:
at a client computer system having one or more processors that execute one or more programs stored in memory of the client computer system:
generating a representation of a web page that is displayed in a window of a web browser in a user interface of the client computer system;
partitioning the representation of the web page into a plurality of tiles based on a document object model of the web page;
for each tile in the plurality of tiles,
determining whether the tile has changed relative to a previous version of the tile; and
in response to determining that the tile has changed, sending the tile that has changed to a server.

2. The computer-implemented method of claim 1, wherein after partitioning the representation of the web page into the plurality of tiles, the method further comprises for each tile in the plurality of tiles, compressing the tile to produce a compressed tile.

3. The computer-implemented method of claim 2, wherein determining whether the tile has changed relative to the previous version of the tile includes:
computing a signature of the compressed tile;
determining whether the signature of the compressed tile is different than a previously computed signature of the previous version of the compressed tile; and
in response to determining that the signature for the compressed tile is different than the previously computed signature of the previous version of the compressed tile, determining that the compressed tile has changed.

4. The computer-implemented method of claim 3, wherein computing the signature of the compressed tile includes computing a hash value of the compressed tile using a hash function.

5. The computer-implemented method of claim 3, further comprising sending the signature of the compressed tile to the server.

6. The computer-implemented method of claim 2, wherein sending the tile that has changed to the server includes sending the compressed tile that has changed to the server.

7. The computer-implemented method of claim 1, wherein determining whether the tile has changed relative to the previous version of the tile includes:
computing a signature of the tile;
determining whether the signature of the tile is different than a previously computed signature of the previous version of the tile; and
in response to determining that the signature for the tile is different than the previously computed signature of the previous version of the tile, determining that the tile has changed.

8. The computer-implemented method of claim 7, wherein computing the signature of the tile includes computing a hash value of the tile using a hash function.

9. The computer-implemented method of claim 7, further comprising sending the signature of the tile to the server.

10. The computer-implemented method of claim 1, wherein partitioning the representation of the web page into the plurality of tiles based on the document object model of the web page includes:
determining a viewable area of the web page based on the document object model; and
partitioning the viewable area of the web page into the plurality of tiles.

11. The computer-implemented method of claim 1, wherein partitioning the representation of the web page into the plurality of tiles based on the document object model of the web page includes:
determining a viewable area of the web page based on the document object model;
determining a scrollable area of the web page based on the document object model; and
partitioning the viewable area and the scrollable area of the web page into the plurality of tiles.

12. The computer-implemented method of claim 1, wherein partitioning the representation of the web page into the plurality of tiles based on the document object model of the web page includes:
determining a viewable area of the web page based on the document object model;
determining a scrollable area of the web page based on the document object model; and
partitioning the viewable area and a subset of the scrollable area of the web page into the plurality of tiles.

13. The computer-implemented method of claim 1, further comprising:
querying the document object model of the web page to determine nodes of the web page that are within each tile;
determining words and/or characters in the nodes based on the document object model; and
sending the words and/or characters to the server.

14. The computer-implemented method of claim 13, further comprising:
determining bounding boxes for the words and/or characters in the nodes based on the document object model; and
sending the bounding boxes to the server.

15. The computer-implemented method of claim 1, wherein in response to determining that the tile has changed, the method further comprises:
generating a timestamp corresponding to a time when the tile was generated; and
sending the timestamp to the server.

16. The computer-implemented method of claim 1, further comprising:
querying the document object model the web page to determine bounding boxes for content within each tile of the plurality of tiles, wherein the content is displayed using plug-in modules of the web browser;
masking areas in each tile corresponding to the bounding boxes;
generating representations of the content; and
sending the representations of the content and the bounding boxes to the server.

17. The computer-implemented method of claim 1, further comprising:
determining a position of a cursor; and
sending the position of the cursor to the server.

18. The computer-implemented method of claim 1, wherein the representation of the web page is an image of the web page.

19. The computer-implemented method of claim 18, wherein the image of the web page is a bitmap image of the web page.

20. The computer-implemented method of claim 1, further comprising:
determining session data; and
sending the session data to the server.

21. A client computer system, comprising:
one or more processors;
memory; and
one or more programs stored in the memory, the one or more programs comprising instructions to:
generate a representation of a web page that is displayed in a window of a web browser in a user interface of the client computer system;
partition the representation of the web page into a plurality of tiles based on a document object model of the web page;
for each tile in the plurality of tiles,
determine whether the tile has changed relative to a previous version of the tile; and
in response to determining that the tile has changed, send the tile that has changed to a server.

22. A computer readable storage medium storing one or more programs configured for execution by a computer, the one or more programs comprising instructions to:
generate a representation of a web page that is displayed in a window of a web browser in a user interface of the client computer system;
partition the representation of the web page into a plurality of tiles based on a document object model of the web page;
for each tile in the plurality of tiles,
determine whether the tile has changed relative to a previous version of the tile; and
in response to determining that the tile has changed, send the tile that has changed to a server.

23. A computer-implemented method for displaying shared web pages, comprising:
at a first client computer system having one or more processors that execute one or more programs stored in memory of the first client computer system:
receiving, from a server, a tile from a plurality of tiles representing a web page that is displayed in a second window of a second web browser in a second user interface of a second client computer system;
determining a position of the tile within the web page; and
displaying the tile at the position within a first window of a first web browser in a first user interface of the first client computer system.

24. The computer-implemented method of claim 23, wherein the tile is an image.

25. The computer-implemented method of claim 23, further comprising:
receiving from the server a current position of a cursor;
determining whether the current position of the cursor is the same as a previous position of the cursor; and
in response to determining that the current position of the cursor is different than the previous position of the cursor,
generating an animation that produces a movement of the cursor from the previous position of the cursor to the current position of the cursor; and
displaying the animation in the first window of the first web browser.

26. The computer-implemented method of claim 23, wherein prior to receiving, from the server, the tile, the method further comprises:
receiving session data;
generating a container within the first window of the first web browser based on the session data;
receiving from the server an initial set of the plurality of tiles;
displaying at least a subset of the initial set of the plurality of tiles in the container in the first window of the first web browser; and
displaying a cursor in the first window of the first web browser based on the session data.

27. The computer-implemented method of claim 23, further comprising:
receiving bounding boxes and corresponding words and/or characters from the server, wherein a respective bounding box corresponds to a specified location of a respective word and/or a respective character within a respective tile;
receiving a search query including search terms from a user of the first client computer system;
determining at least one bounding box including the search terms; and
displaying at least one visual indicator corresponding to the at least one bounding box.

28. The computer-implemented method of claim 23, further comprising:
receiving bounding boxes and representations of content that are displayed using plug-in modules of the second web browser; and
displaying the bounding boxes and the representations of the content in the first window of the first web browser.
